(19) United States
(12) Patent Application Publication
(10) Pub. No.: US 2020/0118205 A1
(43) Pub. Date: Apr. 16, 2020

(54) INTEGRATED CREDIT APPLICATION AND PROVISIONING SOLUTION

(71) Applicant: The Toronto-Dominion Bank, Toronto (CA)

(72) Inventors: Adrian Bloy, Ottawa (CA); Daniel Lam Tin Cheung, Richmond Hill (CA); Asgar Maleki, Toronto (CA); Kevin Yuen, Toronto (CA); Danielle Marie Mullenax, Gatineau (CA)

(21) Appl. No.: 16/161,269

(22) Filed: Oct. 16, 2018

(51) Int. Cl. G06Q 40/02; G06Q 20/40; G06Q 20/36

(52) U.S. Cl. CPC G06Q 40/025; G06Q 20/36; G06Q 20/4014

(57) ABSTRACT

The present disclosure involves systems, software, and computer implemented methods for providing credit application and provisioning operations associated with a financial institution via a secure financial application and mobile wallet. One example method includes receiving a credit application for user. In response to credit approval, a new credit account associated with a set of credentials is created. An indication of approval and the credentials are transmitted via a first channel, and a request to open a secure financial application at a mobile device are transmitted through a second channel. A login request from the secure financial application is received, and if the credentials match the created credentials, a process for initiating onboarding procedures for a digital version of a payment card associated with the new credit account is initiated at the mobile device.

### TECHNICAL FIELD

The present disclosure relates to computer-implemented methods, software, and systems for providing credit application and provisioning operations associated with a financial institution via a secure financial application and mobile wallet, allowing new lines of credit to be immediately available for future transactions without waiting for a physical card to be received.

### BACKGROUND

Online and e-commerce transactions are ubiquitous in today's society. Many merchants, including those with brick and mortar locations, have found more and more of their sales to be delivered via online or connected channels. Using merchants' online platforms, customers may use their existing payment methods to complete transactions.

New credit applications typically result in a period of time during which an initial transaction may be available or allowable in response to a credit application acceptance and usage. However, the generated card may only be available for the single usage, and may not be available for future transactions. Further, any credit account may result in contingent liability on the part of the providing merchant.

### SUMMARY

The present disclosure involves systems, software, and computer-implemented methods for providing credit application and provisioning operations associated with a financial institution via a secure financial application and mobile wallet. A first example system includes a communications module, at least one memory storing instructions, a repository storing a set of credit accounts, and at least one hardware processor interoperably coupled with the at least one memory and the communications module, wherein the instructions instruct the at least one hardware processor. Each credit account is associated with a user and a user-specific set of credentials. The instructions can cause to hardware processor to perform the following operations, including receiving, via the communications module, a first signal including data associated with an application for a credit account for a first user. A credit adjudication process can be performed based on the received data associated with the application for the credit account for the first user. In response to an approval during the credit adjudication process, a new credit account associated with the first user is created, where the new credit account is associated with a set of first user-specific credentials. A second signal including an indication of the approval of the credit application and the set of first user-specific credentials can be transmitted via the communications module and through a first communication channel. A third signal including an instruction request opening of a secure financial application at a mobile device associated with the first user can be transmitted via the communications module and through a second communication channel. A fourth signal including a login request associated with the set of first user-specific credentials can be received via the communications module and from the secure financial application executing on the mobile device associated with the first user. In response to validating the received set of first user-specific credentials as associated with the first user and the new credit account, a fifth signal including an indication to allow initiation of onboarding procedures for a digital version of a payment card associated with the new credit account at the mobile device can be transmitted via the communications module and to the secure financial application. In response to fifth signal, the secure financial application can initiate interaction between the secure financial application, a mobile wallet application associated with a mobile wallet of the mobile device, and a payment network token service, wherein, in response to the initiated interaction, the payment network token service transmits, via a sixth signal to the mobile wallet executing on the mobile device, a generated digital version of the payment card associated with the new credit account. The mobile wallet then stores the digital version of the payment card for use in future transactions.

Implementations can optionally include one or more of the following features.

In some instances, the first signal including data associated with the application for the credit account for the first user is received from a first device different than the mobile device.

In some instances, the first signal including data associated with the application for the credit account for the first user is received from a client application executing at the mobile device.

In some instances, the secure financial application comprises a mobile banking application provided by a financial institution. The secure financial application is configured to create a secure communications channel to the financial institution.

In some instances, the interaction between the secure financial application, the mobile wallet application, and the payment network token service comprises a three-way handshake between the secure financial application, the mobile wallet application, and the payment network token service.

In some instances, storing the digital version of the payment card for use in future transactions is performed before a physical version of the payment card is generated.

In some instances, no physical version of the payment card is generated for the new credit account.

In some instances, the second signal and the third signal are sent in a single signal via a common communications channel.

In some instances, the first communication channel is different than the second communication channel.

In some instances, the instruction requesting opening of the secure financial application at the mobile device associated with the first user includes an instruction to download the secure financial application from an app store corresponding to an operating system of the mobile device if the secure financial application is not installed on the mobile device.

In some instances, the digital version of the payment card associated with the new credit account comprises a payment token generated by the payment network token service, wherein the payment token is used in lieu of a personal account number (PAN) to complete transactions using the new credit account.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer-implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for providing credit application and provisioning operations associated with a financial institution via a secure financial application and mobile wallet.

FIG. 2 illustrates a data and control flow of example interactions performed in providing credit application and provisioning operations associated with a financial institution via a secure financial application and mobile wallet in one example implementation.

FIG. 3 is a flow diagram of an example method for providing credit application and provisioning operations associated with a financial institution via a secure financial application and mobile wallet from a perspective of a client device in one example implementation.

FIG. 4 is a flow diagram of an example method for providing credit application and provisioning operations associated with a financial institution via a secure financial application and mobile wallet from a perspective of the financial institution in one example implementation.

### DETAILED DESCRIPTION

The present disclosure describes various tools and techniques associated with providing credit application and provisioning operations associated with a financial institution. Specifically, the described solution allows customers and the financial institution to provision new cards on-the-fly without requiring a physical card to be generated before the customer can use the card to begin performing transactions with various merchants and providers. Further, the current solution is not tied to a particular merchant, but is instead an interaction performed between the customer and financial institution. Users or customers (referred to herein as “users” or “customers”, interchangeably) may be associated with or may transact business with one or more merchants or providers once the accounts are generated, and can then transact business with one or more merchants using a digital version of a corresponding card via the user's mobile wallet. The generated account may at some point be associated with a physical card; however, the card is not needed to allow transactions to begin. Using a secure financial application associated with the financial institution implementing significant safety and privacy requirements, the financial institution can allow customers to apply and be approved for a new account, then subsequently and immediately have a digital version of a card associated with the account be provisioned to the customer's mobile wallet on their device such that the card is available for instant purchasing ability.

While some solutions may be directed to a merchant-specific transaction and merchant-related card, the present solution for providing apply and buy capabilities is merchant-agnostic and can be used where a commercial mobile wallet (e.g., Apple Pay, Google Pay, etc.) is used to store payment card information and use stored payment cards for completing transactions, such as via a mobile device. New credit accounts can be applied for via a secure financial application executing on the customer's mobile device, for example, and can then be immediately available for use in a new transaction with one or more merchants and in all other future transactions with other merchants and providers. In some instances, the credit may be applied for just before or during a current transaction, while in other instances, the credit may be applied for separate from any particular transaction. In some instances, an offer for credit can be provided to the user during a shopping or transaction session with a merchant X. In other instances, an offer for credit may be provided via email, at a financial institution website, in a financial institution application or mobile app, or via any other channel. In some instances, the interactions to apply for the new credit may be performed on a mobile device through a web browser or an application associated with or provided by the financial institution, while in some instances, interactions with a particular merchant X may be associated with the offer (e.g., through a partnership with the financial institution, via advertising for the financial institution, or through another channel). In response to an indication that the customer is interested in applying for the credit, the customer can be directed to a banking website or application associated with the financial institution based on the indication that the user intends to apply for the credit. The banking website or application may be a mobile app available to the user on a client device, or may be a banking website available via a web browser. At the website or application, information for the credit application can be captured.

From the banking website or application, once the credit application information is submitted, the information can be transmitted to a corresponding financial institution system, where a credit adjudication process can receive the information and perform the credit application analysis. In response to receiving approval of the credit, the credit adjudication system can provide the user information to a credit provisioning system, where a new credit account can be created and new payment credentials can be generated. Information associated with or identifying those credentials can be returned to the banking website or application.

Upon receiving the credentials, the banking website or application can push operations from the banking website or application to a secure mobile application, such as by initiating the secure mobile banking application to be opened. Once the secure mobile banking application is executing, a secure communication channel between the secure mobile application and the backend provisioning system can be opened to complete opening of the account, and to push information associated with the payment credentials to the secure mobile banking application. In addition to receiving the secure credentials, instructions to forward the payment credentials to a commercial mobile wallet associated with the user's client device can be provided. The secure mobile banking application can then initiate a three-party handshake for provisioning a digital version of the credit card or payment credentials into the commercial wallet with the mobile wallet application and a payment network token service. Based on the handshake and the confirmation of the particular device, the payment network token service can generate a payment token associated with the account and provide that token to the commercial mobile wallet application, storing the payment credentials and making the credit account available for use via the mobile wallet at any compatible merchant or provider.

Benefits of this, in addition to providing an immediate method of payment for any transactions, can include the fact that no physical card may be needed for future transactions. Using the host card emulation provided by the stored payment credentials and the commercial wallet, the user would not need to travel with a physical card associated with a new account. Further, the application process can be performed immediately, and, if the credit application is approved, the credit can be available in seconds or minutes and available to use immediately upon receipt of the digital version of the credit card.

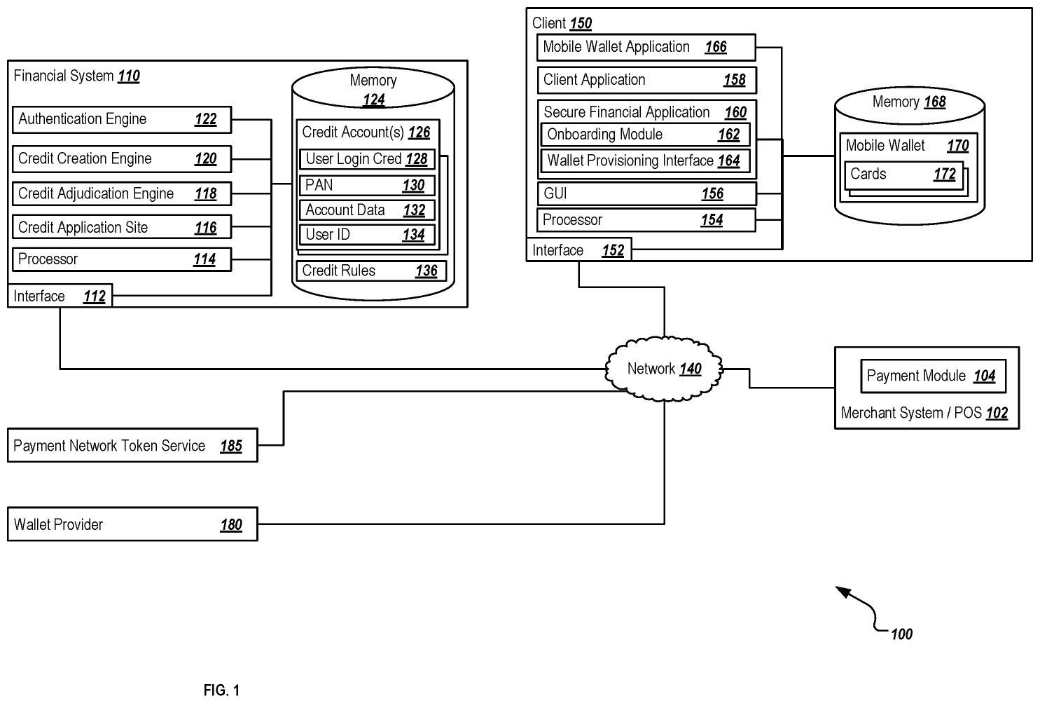

Turning to the illustrated example implementation, FIG. 1 is a block diagram illustrating an example system 100 for providing credit application and provisioning operations associated with a financial institution via a secure financial application and mobile wallet. Specifically, the illustrated implementation is directed to a solution where a customer can initially interact with a financial system 110 of a particular financial institution to apply for credit at a credit application site 116 (e.g., via a client application 158, which may be a mobile application or web browser). The credit application can be considered and processed by the financial institution, which can perform the credit analysis to determine whether the required credit application should be approved. In response, the financial system 110 can generate a new credit account 126 and provide a set of user login credentials to the customer via the client application 158 or any other suitable communication channel. The login credentials can be associated with an instruction or other indication for the customer to open or initiate a secure financial application 160 on the client 150. In some instances, the customer may be prompted to download or install the secure financial application 160 from an app store associated with the client's operating system. Upon opening the secure financial application 160, the customer can input the newly received credentials and confirm their identity. Once open, the secure financial application 160 can complete the onboarding process associated with the new credit account with the financial system 110, and the secure financial application 160 can initiate a three-way handshake between the secure financial application 160, a wallet provider 180 and/or the mobile wallet application 166, and a payment network token service 185. In response to a successful handshake, the payment network token service 185 can generate a payment token associated with the new credit account, and can provide that token to the wallet provider 180 and/or the mobile wallet application 166, such that a digital version of a credit card associated with the new credit account 126 can be provided to and stored at the mobile wallet 170 of the client 150, where the payment token can be used to immediately perform transactions using those credentials.

In general, system 100 allows the illustrated components to share and communicate information across devices and systems (e.g., merchant system 102, financial system 110, client 150, payment network token service 185, and wallet provider 180, among others, via network 140). As described herein, any of the systems, including the financial system 110 and/or merchant system 102 may be cloud-based components or systems (e.g., partially or fully), while in other instances, non-cloud-based systems may be used. In some instances, non-cloud-based systems, such as on-premise systems, client-server applications, and applications running on one or more client devices, as well as combinations thereof, may use or adapt the processes described herein. Although components are shown individually, in some implementations, functionality of two or more components, systems, or servers may be provided by a single component, system, or server.

As used in the present disclosure, the term “computer” is intended to encompass any suitable processing device. For example, financial system 110, merchant system 102, and client 150 may be or may be associated with any computer or processing devices such as, for example, a blade server, general-purpose personal computer (PC), Mac®, workstation, UNIX-based workstation, or any other suitable device. Moreover, although FIG. 1 illustrates a single financial system 110, system 110 can be implemented using a single system or more than those illustrated, as well as computers other than servers, including a server pool. Other illustrated components may be similarly separated, where suitable. In other words, the present disclosure contemplates computers other than general-purpose computers, as well as computers without conventional operating systems. Similarly, the client 150 may be any system that can request data and/or interact with the merchant system 102 and the financial system 110. The client 150, also referred to as client device 150, in some instances, may be a desktop system, a client terminal, or any other suitable device, including a mobile device, such as a smartphone, tablet, smartwatch, or any other mobile computing device. In general, each illustrated component may be adapted to execute any suitable operating system, including Linux, UNIX, Windows, Mac OS®, Java™, Android™, Windows Phone OS, or iOS™, among others. The client 150 may include one or more financial institution-specific applications executing on the client 150 (e.g., secure financial application 160), or the client 150 may include one or more Web browsers or web applications that can interact with particular applications executing remotely from the client 150, such as credit application site (or a similar API) 116 , among others.

As noted, the financial system 110 provides a backend system associated with a financial institution used to receive credit applications for credit, where the application for credit can be immediately evaluated and, if approved, a corresponding new credit account 126 can be generated. Once the credit account is generated, the financial system 110 can transmit, back to the client device 150 associated with the request, login credentials associated with the newly created credit account 126, along with instructions to open (and, if necessary, install) the secure financial application 160 to complete the credit account generation and digital wallet provisioning process. Once a login is confirmed via the secure financial application 160 with the verified credentials at the authentication engine 122, the credit account 126 can be activated and an onboarding process can be initiated.

As illustrated, the financial system 110 includes or is associated with interface 112, processor(s) 114, credit application site or API 116, credit adjudication engine 118, credit creation engine 120, authentication engine 122, and memory 124. While illustrated as provided by or included in the financial system 110, parts of the illustrated contents may be separate or remote from the financial system 110, or the financial system 110 may be distributed.

The interface 112 of the financial system 110 is used by the financial system 110 for communicating with other systems in a distributed environment—including within the environment 100—connected to the network 140, e.g., client 150, wallet provider 180, and payment network token service 185, as well as other systems communicably coupled to the illustrated financial system 110 and/or network 140. Generally, the interface 112 comprises logic encoded in software and/or hardware in a suitable combination and operable to communicate with the network 140 and other components. More specifically, the interface 112 may comprise software supporting one or more communication protocols associated with communications such that the network 140 and/or interface's hardware is operable to communicate physical signals within and outside of the illustrated environment 100. Still further, the interface 112 may allow the financial system 110 to communicate with the client 150 and/or other portions illustrated within the financial system 110 to perform the operations described herein.

Network 140 facilitates wireless or wireline communications between the components of the environment 100 (e.g., between the financial system 110, merchant system 102, the client(s) 150, etc.), as well as with any other local or remote computers, such as additional mobile devices, clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components (e.g., the merchant system 102, the financial system 110, etc.) may be included within or deployed to network 140 or a portion thereof as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11a/b/g/n/ac, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

The financial system 110, as illustrated, includes one or more processors 114. Although illustrated as a single processor 114 in FIG. 1, multiple processors may be used according to particular needs, desires, or particular implementations of the environment 100. Each processor 114 may be a central processing unit (CPU), an application specific integrated circuit (ASIC), a field-programmable gate array (FPGA), or another suitable component. Generally, the processor 114 executes instructions and manipulates data to perform the operations of the financial system 110. Specifically, the processor 114 executes the algorithms and operations described in the illustrated figures, as well as the various software modules and functionality, including the functionality for sending communications to and receiving transmissions from the client 150, as well as to other devices and systems. Each processor 114 may have a single or multiple core, with each core available to host and execute an individual processing thread. Further, the number of, types of, and particular processors 114 used to execute the operations described herein may be dynamically determined based on a number of requests, interactions, and operations associated with the financial system 110.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Peri®, any suitable version of 4GL, as well as others.

The credit application site 116 may be a web page, web-based application, API, or other software provided by or associated with the financial system 110. The credit application site 116 represents an interactive website, form, or other interactive component at which information associated with a credit application can be submitted. The credit application site 116 may be a front-end used to receive input for the credit application, and can provide the received information to one or more backend systems, such as the credit adjudication engine 118 and the credit creation engine 120. In some instances, the credit application site 116 may receive, from client application 158, information from the client 150 regarding a customer and a request for credit. In some instances, the information received from the client 150 may include a set of information describing the customer, and/or identifying an existing credit or financial account managed by or associated with the financial system 110 and/or the financial institution. In some instances, the customer or user, via client application 158, can input the required information associated with the credit application to the credit application site 116 (e.g., via a suitable input method). In other instances, a set of personally identifiable information from an existing account or other source, including that stored on client 150 itself, may be referenced, included, or otherwise identified and provided to the credit application site 116. In some instances, at least some of the existing information can be used to pre-populate at least a portion of the credit application at the credit application site 116. In some instances, all fields may be populated, and the user may only need to submit the application after review. The credit application site 116 may provide the user with a set of terms and conditions associated with the issuance of new credit, allowing the financial institution to conform to any local, state, or federal requirements. In some instances, the credit application may be completed locally via the client application 158, and can then be submitted via network 140 to the credit application site 116.

Once the credit application is completed and submitted, the credit application site 116 can provide the relevant information to a credit adjudication engine 118, where the credit adjudication engine 118 can perform a creditworthiness analysis based on one or more credit rules 136 defined by the financial institution (and here, stored in memory 124). The credit rules 136 can be used to determine whether the credit application is to be accepted or rejected, as well as an amount associated with the acceptance, where appropriate. The credit adjudication engine 118 can access one or more databases and credit bureaus when making its determination, and, in some cases, can provide an instantaneous or near-instantaneous decision regarding the credit application.

In response to approving the credit application, the credit adjudication engine 118 can cause a credit creation engine 120 to create a new credit account 126 for the customer as approved during the adjudication process. The credit creation engine 120 may act as a master account management system, and can perform credit provisioning and management within the financial system 110. In some instances, the credit creation engine 120 may be a credit management system offered by TSYS or another vendor. Based on the instructions from the credit adjudication engine 118, the credit creation engine 120 generates the new credit account 126, as well as some or all of the information associated with the customer received from the credit application, which can be stored in the account data 132. In some instances, a personal account number (PAN) 130 may be generated for the credit account 126, which may be identical to the account number of the new credit account 126, or may be an alternative identifier to be used in transactions. In many instances, the result of the credit generation process is the creation of a new, unique account number that can be used to perform one or more transactions on the new credit account. In some instances, the credit creation engine 120 can generate or otherwise obtain a payment token associated with the new credit account 126, where the payment token can be used in lieu of the account number or PAN 130 to initiate a transaction at various merchants and providers. In addition, a set of user login credentials 128 can be generated that are associated with the new account 126. Those credentials 128 can be transmitted back to the client application 158, along with a request or instructions to the customer and/or the client 150 to open and login via the secure financial application 160. The request and instructions can be sent via any suitable communication channel, including back through the client application 158 or via alternate channels, such as email, text- or multimedia messaging services, or a financial institution-related app or application other than the client application 158. The financial system 110 can then identify, in response to those instructions, a login attempt from the secure financial application 160 associated with the user login credentials 128. The authentication engine 122 can authenticate and verify the login attempt and the user, and provide a responsive communication confirming the login in. Instructions can then be provided back to the secure financial application 160 authorizing the onboarding process to finalize the credit account 126 and begin provisioning a digital version of a credit card associated with the credit account 126 to the client's mobile wallet 170.

Memory 124 of the financial system 110 may represent a single memory or multiple memories. The memory 124 may include any memory or database module and may take the form of volatile or non-volatile memory including, without limitation, magnetic media, optical media, random access memory (RAM), read-only memory (ROM), removable media, or any other suitable local or remote memory component. The memory 124 may store various objects or data, including financial data, user and/or account information, administrative settings, password information, caches, applications, backup data, repositories storing business and/or dynamic information, and any other appropriate information associated with the financial system 110, including any parameters, variables, algorithms, instructions, rules, constraints, or references thereto. Additionally, the memory 124 may store any other appropriate data, such as VPN applications, firmware logs and policies, firewall policies, a security or access log, print or other reporting files, as well as others. While illustrated within the financial system 110, memory 124 or any portion thereof, including some or all of the particular illustrated components, may be located remote from the financial system 110 in some instances, including as a cloud application or repository, or as a separate cloud application or repository when the financial system 110 itself is a cloud-based system. As illustrated and previously described, memory 124 includes a plurality of credit accounts 126 associated with particular customers, where each credit account 126 may be associated with a corresponding user ID 134, the set of user login credentials 128, a PAN 130, and a set of account data 132. Additional and/or alternative information may be stored in or associated with memory 124.

While not illustrated herein, once a new credit account is generated, the financial system 110 may optionally trigger a physical card generation process, where a physical card is generated and can be physically delivered to the user. Any suitable process for card generation can be used, and can allow the user to use the new credit account offline and at locations where use of the mobile wallet 170 is not available and/or accepted. In some instances, no physical card may be generated after the credit account 126 is generated.

As illustrated, one or more clients 150 may be present in the example system 100. Each client 150 may be associated with a particular customer, or may be accessed by multiple customers, where a particular customer is associated with a current session or interaction at the client 150. Client 150 may be a client device at which a particular customer is linked or associated, or a client device through which the particular customer, using a client application 158, can interact with the financial system 110. As illustrated, the client 150 may include an interface 152 for communication (similar to or different from interface 112), at least one processor 154 (similar to or different from processor 114), a graphical user interface (GUI) 156, client application 158, a secure financial application 160, a mobile wallet application 166, and a memory 168 (similar to or different from memory 124).

The illustrated client 150 is intended to encompass any computing device such as a desktop computer, laptop/notebook computer, mobile device, smartphone, personal data assistant (PDA), tablet computing device, one or more processors within these devices, or any other suitable processing device. In general, the client 150 and its components may be adapted to execute any operating system, including Linux, UNIX, Windows, Mac OS®, Java™, Android™, or iOS. In some instances, the client 150 may comprise a computer that includes an input device, such as a keypad, touch screen, or other device(s) that can interact with one or more client applications, such as one or more mobile applications, including a web browser, mobile wallet or other banking application, and an output device that conveys information associated with the operation of the applications and their application windows to the user of the client 150. Such information may include digital data, visual information, or a GUI 156, as shown with respect to the client 150. Specifically, the client 150 may be any computing device operable to communicate with the financial system 110, other clients 150, one or more merchant or other provider systems 102, a payment network token service 185, a wallet provider 180, and/or other components via network 140, as well as with the network 140 itself, using a wireline or wireless connection. In general, client 150 comprises an electronic computer device operable to receive, transmit, process, and store any appropriate data associated with the environment 100 of FIG. 1.

The client application 158 executing on the client 150 may include any suitable application, program, mobile app, or other component. Client application 158 can interact with the financial system 110, one or more merchant systems 102 (e.g., to browse and/or purchase goods and services, etc.), or other systems, via network 140. In some instances, the client application 158 may be a web browser, where the functionality of the client application 158 may be realized using a web application or website the user can interact with via the client application 158. In other instances, the client application 158 may be a remote agent, component, or client-side version of the financial system 110, or a dedicated application associated with the financial system 110. In some instances, the client application 158 may interact directly with the financial system 110 or portions thereof. The client application 158 may be used to view or interact with the financial system 110, and can allow or provide interactions for credit application submission via the financial system 110.

GUI 156 of the client 150 interfaces with at least a portion of the environment 100 for any suitable purpose, including generating a visual representation of any particular client application 158, the mobile wallet application 166, the secure financial application 160, and/or the content associated with any components of the financial system 110. In particular, the GUI 156 may be used to present screens and information associated with submitting the credit application and logging in via the secure financial application 160, as well as using the mobile wallet application 166 and performing transactions via the client application 158, among others. GUI 156 may also be used to view and interact with various web pages, applications, and web services located local or external to the client 150. Generally, the GUI 156 provides the user with an efficient and user-friendly presentation of data provided by or communicated within the system. The GUI 156 may comprise a plurality of customizable frames or views having interactive fields, pull-down lists, and buttons operated by the user. In general, the GUI 156 is often configurable, supports a combination of tables and graphs (bar, line, pie, status dials, etc.), and is able to build real-time portals, application windows, and presentations. Therefore, the GUI 156 contemplates any suitable graphical user interface, such as a combination of a generic web browser, a web-enable application, intelligent engine, and command line interface (CLI) that processes information in the platform and efficiently presents the results to the user visually.

The secure financial application 160 may be a dedicated application associated with the financial system 110, and may include additional security (e.g., secure channel to the financial system 110, advanced encryption, etc.) and user identification authentication and authorization methods (e.g., device fingerprints, biometric authentication, etc.). Once the secure financial application 110 is open and a secure connection is established to the financial system 110, the customer can log into the financial system 110 (after being authenticated by authentication engine 122) using the user login credentials 128 provided by the at least one other channel.

The secure financial application 160 can include an onboarding module 162 and a wallet provisioning interface 164. The onboarding module 162 can, after the customer successfully logs in via the secure financial application 160 using the credentials 128, perform operations for onboarding the new digital version of a credit card or other payment instrument associated with the new credit account 126. In some instances, the onboarding module 162, via the wallet provisioning interface 164, can initiate a three-way handshake between the financial system 110 and/or the secure financial application 160, the wallet provider 180 and/or the mobile wallet application 166, and the payment network token service 185. In response to the handshake, the customer's specific identity can be confirmed, as well as a request to the payment network token service 185 to generate a payment token associated with the new credit account 126 of the customer. The payment token can be used as a substitute for the physical credit card associated with the credit account, and can be provided to the wallet provider 180 (e.g., a backend system associated with the mobile wallet applications 166, which can store payment tokens for various card accounts) or directly to the mobile wallet application 166 executing on the client 150. In either event, the payment token can then be provisioned to and saved at the mobile wallet 170 of the client 150, where the payment token can be associated with a corresponding payment card 172, and can be used immediately to complete local or online transactions using the mobile wallet application 166.

Mobile wallet application 166 may be any suitable commercial wallet, where the wallet application 166 stores or manages a mobile wallet 170 identifying or storing one or more digital versions of payment cards 172 corresponding to the one or more credit accounts 126 of the customer. Those cards 172 are accessible by the user of the client 150 to perform one or more transactions without requiring manual input of payment credentials or information. The mobile wallet 170 may be a virtual wallet storing payment card information on the client 150, and those payment cards may be used to make in-store payments (e.g., via near-field communication (NFC) transactions) or online with merchants listed or associated with the mobile wallet service provider. Once the mobile wallet application 166 is installed and the cards 172 are associated with the mobile wallet 170, the wallet 170 stores card and payment tokens linked to a personal identification format, such as a number or key, QR code or an image of the card for each card 172 stored in or associated with the wallet 170. In some instances, the new credit account 126 information, or at least the payment credential information, can be stored within the wallet 170, allowing the user to use the payment credentials associated with the new credit account at any number of locations after the information is generated.

The payment network token service 185, described above, may be associated with any suitable or associated payment network associated with the new credit account 126. For example, if the new credit account 126 is associated with a new Visa card, then the payment network token service 185 may be a Visa-associated service capable of generating payment tokens and credentials related to or associated with the credit account 126. Other payment networks may also be used, while third-party services authorized by the payment networks and financial systems 110 may also be used instead. The tokens created by the service 185 can link the tokens to actual accounts 126 without specifically identifying the PAN 130 or account number of the credit account 126, allowing more secure transactions to be performed.

Once the digital version of the credit card is provisioned to the mobile wallet 170, transactions can be performed with various merchants, including merchant system 102 (via its payment module 104). Payments and transaction may be performed in person using the mobile wallet 170 and the mobile wallet application 166 through NFC-based transactions or remotely using the client application 158 and payments provided via the mobile wallet application 166. The merchant system 102 may be associated with a particular merchant, and may be associated with or part of an e-commerce site at which a user can interact to perform one or more shopping or purchase transactions, such as through the merchant web page or application.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

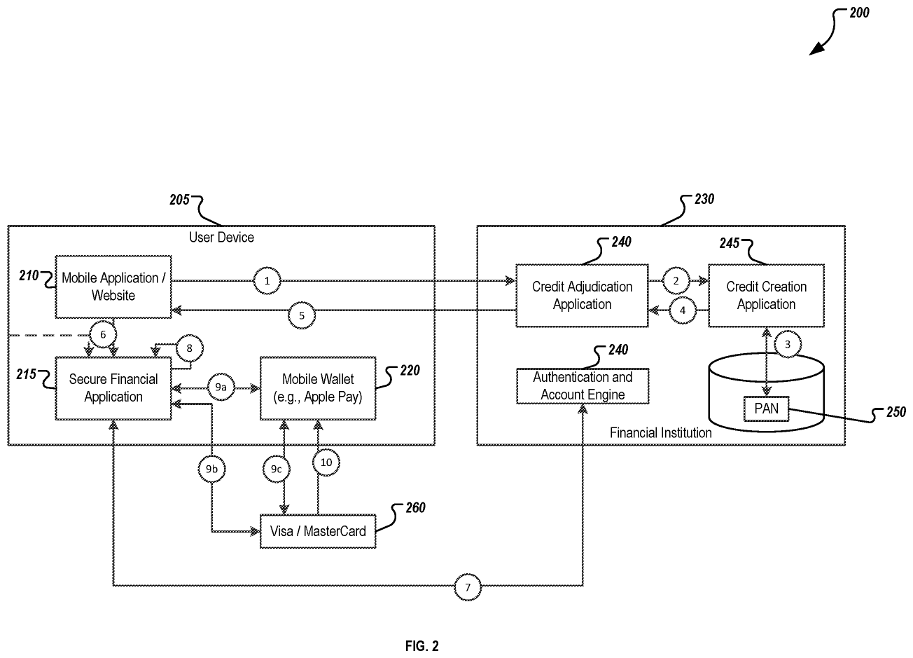

FIG. 2 illustrates a data and control flow of example interactions 200 performed in providing credit application and provisioning operations associated with a financial institution via a secure financial application and mobile wallet in one example implementation. As shown, FIG. 2 is illustrated with interactions between a user device 205, a financial institution 230, and a payment network 260 (e.g., Visa or MasterCard's networks). In some instances, these may correspond to the client 150, financial system 110, and payment network token service 185 of FIG. 1, respectively, although different specific implementations may be used by persons of skill in the art.

As illustrated in FIG. 2, the user device 205 may be associated with a web browser or application 210, where the web browser or application 210 is used to interact with various websites, web pages, and/or web applications. In some instances, the mobile application 210 may be used to browse to a web page associated with the financial institution 230, where a credit application can be provided. In other instances, the mobile application 210 may be associated with the financial institution 230, and may provide a built-in or stored credit application that can then be provided back to the financial institution 230 when completed. Once the application is completed, or inputs associated with a credit application are completed, that information can be transmitted to the financial institution 230 as shown by arrow 1. While illustrated as being provided directly to the credit adjudication application 240, the inputs and/or interactions may initially be directed to a credit application site or a set of credit application APIs, where the credit application site and/or APIs provides a front-end to the credit adjudication application 240 and the credit creation application 245 on the backend. If the credit application site is used, it may be a website, webpage, web-based application, or set of web-based APIs at which users are able to provide inputs for a credit application for a new credit account.

Once the credit application is completed and submitted, the credit adjudication application 240 can perform an analysis to determine whether the credit request is to be approved. Any suitable information may be used in the determination, including information about the customer applying for the credit, information about one or more existing accounts of the customer at the financial institution 230, and the answers provided in the credit application, among others. The credit adjudication application 240 may obtain additional information from the customer in response to receiving the credit application, and may perform additional roundtrips and/or requests back to the user device 205 for additional information. Additionally, one or more credit bureaus may be contacted and queried in relation to the applying customer. In response to determining that the credit is approved, the credit adjudication application 240 can provide information regarding the approval (e.g., approved, a particular credit limit, etc.) to the credit creation application 245 (as shown by 2).

The credit creation application 245 can create a new credit account based on the received information, including identifying a new PAN 250 or other account identifying information (at 3). The PAN 250 may be or may be associated with a set of payment credentials that can be used by the user to perform financial transactions upon the newly approved credit account. The PAN 250 and associated credit account can be associated with the customer and the customer's information received from the credit application, and any other information required to provide and manage the credit account. In response to the creation of the credit, the credit creation application 245 (and/or any other component) may generate a set of user login credentials to be associated with the new account. These credentials can be used to securely log into the financial institution 230 via a secure financial application 215 executing at the user device 205, where the secure financial application 215 can allow the customer to securely interact with the financial institution 230 and its new credit accounts, including to provision a digital version of a credit card or other payment instrument associated with the new credit account to a mobile wallet 220 associated with the customer and the user device 205. A notification of the credit creation, and information related to the user credentials, may be provided back to the credit adjudication application (as shown by 4). Alternatively, the credit creation application 245 may provide the notification to the credit application site (where used), directly to the mobile application 210, or in some manner to the customer associated with the user device 205 (e.g., via email, text messaging, or an alternative communication channel).

At 5, information related to the credit approval and credit account creation can be provided back to the mobile application 210. In addition, the information may include an instruction to the mobile application 210 or user device 205 to open and, if necessary, download or install the secure financial application 215. In some instances, as shown by 6, the mobile application 210 can then open the secure financial application 215 and allow the customer to complete the credit provisioning process. As noted, the opening of the secure financial application 215 can be performed automatically by the mobile application 210, in response to the user selecting a hyperlink or provided URL associated with the secure financial application 215 provided via the mobile application 210, or based on a manual interaction performed by the customer in response to a message or instruction received outside of the mobile application 210. The secure financial application 215 is used in this instance, as the information provided to the user device 205 requires higher security and data protection, and the secure financial application 215 can be built to provide banking industry-strength data protection, users authentication techniques, and secure communications to the financial institution 230.

Once open, the customer can log into the financial institution 230 and its systems using the secure financial application 215 and the customer-specific login credentials received with or in association with the credit approval (as shown by 7). The credentials can be sent, via the secure financial application 215, to an authentication engine 240 of the financial institution 230, which can perform identity authentication and verification on the customer, the user device 205, and the new credit account associated with the credentials. Once a successful login is achieved, the secure financial application 215 can begin an onboarding process to be initiated (as shown by 8). During the process, a three-way handshake and verification process between the secure financial application 215, mobile wallet 220, and payment network 260 is performed to verify and acknowledge the customer logged into the secure financial application 215, the credit account associated with the customer, that a payment token is to be generated for the mobile wallet 220 by the payment network 260, and the general token approval process between the card network 260 and the mobile wallet 220. The interactions of the handshake are illustrated as 9a, 9b, and 9c in FIG. 2. Once the handshake is complete and successful, or as part of the handshake, the payment network 260 can generate and provide a payment token representing a digital version of a card associated with the new credit account to the mobile wallet 220 (as shown by 10) for storage and use at the user device 205 for future transaction.

FIG. 2 is meant to be an example of the flows and interactions between an example set of components performing the operations described herein. Additional, alternative, or different combinations of components, interactions, and operations may be used in different implementations.

By providing the solution illustrated in FIG. 2, no physical card may be needed after the new credit account is created and the payment tokens (or digital versions of the credit cards) are stored on the user device 205 in the mobile wallet 220. Additionally, by provisioning the payment tokens directly to the mobile wallet 220, the new credit account may be used immediately to purchase and transact with multiple merchants and providers.

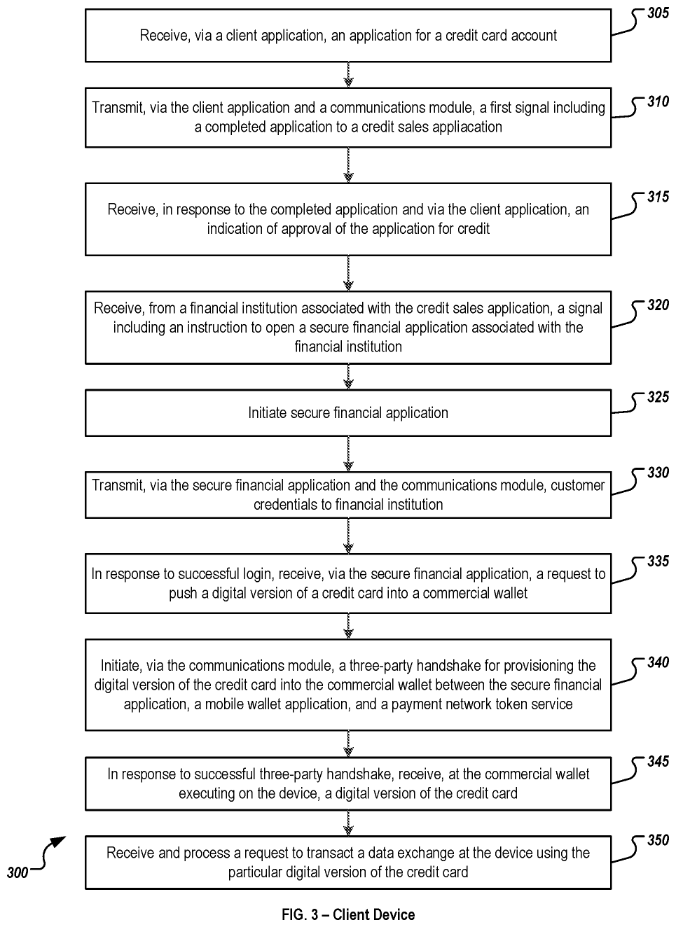

FIG. 3 is a flow diagram of an example method for providing credit application and provisioning operations associated with a financial institution via a secure financial application and mobile wallet from a perspective of a client device in one example implementation. However, it will be understood that method 300 may be performed, for example, by any other suitable system, environment, software, and hardware, or a combination of systems, environments, software, and hardware as appropriate.

At 305, an application for a credit card (or other credit type) account is received via a client application. In some instances, the client application may be specifically associated with or provided by a financial institution associated with the credit application, while in other instances the client application may be a web browser, such as a mobile web browser used to access or interact with a financial system website or web-based application. The credit application may be completed using information input by a user or customer interacting with the client device. In other instances, information stored at the client device, or accessed from the financial system, may be used as initial input to the credit application.

Once complete, the application can be transmitted, via the client application and its communication module, to a credit sales application or API provided by the financial system or institution at 310. In some instances, the application may be entered into a web-based form or application, such that 310 comprises transmitting the inputs associated with the credit application. Once submitted, the financial system can perform a credit adjudication and creation process to determine whether the application is approved, as well as other account details.

At 315, in response to the submission of the completed application, a second signal including an indication of approval of the credit application can be received, via the communications module, at the client application. The indication may be received within seconds, and may be presented via a screen or pop-up indicating that a new account has been approved and created. In some instances, a set of account information, such as an account identifier, may be provided.

At 320, a third signal including an instruction to open or initiate a secure financial application associated with the financial system may be received from the financial institution associated with the credit application and the new credit account. The third signal may be received through the same channel as the indication of approval, including in the same signal as the indication, or the third signal may be received through a different communication channel. For example, while the second signal may be received through a communication channel associated with the client application, the third signal may be received via a different channel, such as through an email message, a text message, a desktop or pop-up notification, a phone call, or through any other mechanism or channel. In some instances, the instruction may also include a conditional instruction to download or install the secure financial application if the client device does not already include an installed version.

In some instances, the third signal may include a set of user credentials generated during the credit adjudication process that can be used by the customer to log into the secure financial application. Because the secure financial application provides a secure connection to the financial system and/or institution, the secure financial application must be used to initiate a local provisioning of a payment token corresponding to the new account. The newly received set of credentials can then be used to authenticate the customer/user and the user device before provisioning the digital card to the device.

At 325, the secure financial application can be initiated and/or opened. In some instances, as described, the secure financial application can be first downloaded from an appropriate app store or other suitable location. At 330, the set of customer credentials can be transmitted, via the secure financial application and the communications module, to the financial institution. Once verified, method 300 continues at 335.

At 335, in response to a successful login attempt, the secure financial application can receive a request to push or provision a digital version of a credit card associated with the new credit account into a commercial wallet. The commercial wallet can be stored at the client device, and can be used to store payment tokens usable in transactions without the need for a credit card. In some instances, the request to push or provision the digital version may be a manual request from the user, while in others, the process may be automatically requested or initiated by the secure financial application.

In response to the request, at 340, the secure financial application can initiate, via the communications module, a three-party handshake for provisioning the digital version of the credit card into the commercial wallet in an interaction between the secure financial application, a mobile wallet application, and a payment network token service. The three-way handshake can provide authentication between the systems, identify the request for the payment token at the payment network token service, and prepare the mobile wallet application for provisioning. In response to a successful three-party handshake, the client device can receive, at the commercial wallet application executing on the client device, a digital version of the credit card associated with the credit account from the payment network token service at 345. The digital version of the credit card can then be stored in the mobile wallet, and can be used to perform future transactions.

As an example, at 350, a request to transact a data exchange, such as a purchase, may be received at the client device. The request can be processed and transacted using a particular stored digital version of the credit card via the commercial wallet and the mobile wallet application executing at the client device.

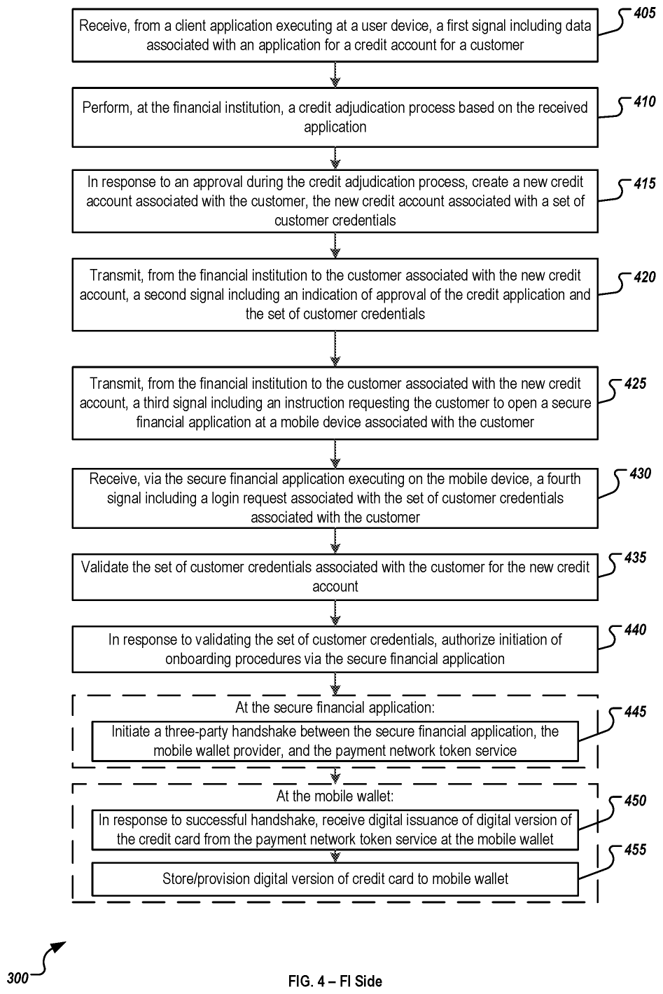

FIG. 4 is a flow diagram of an example method 400 for providing credit application and provisioning operations associated with a financial institution via a secure financial application and mobile wallet from a perspective of the financial institution in one example implementation. However, it will be understood that method 300 may be performed, for example, by any other suitable system, environment, software, and hardware, or a combination of systems, environments, software, and hardware as appropriate.

At 405, a first signal is received from a client application executing at a user device via a communications module, where the first signal includes data associated with an application for a credit account for a customer. The first signal can include inputs provided by the user via a browser or dedicated application for an application process, and can be received at any suitable location, including one or more credit application APIs or via a credit application website providing a credit application form, among others. In some instances, the credit application may be received via a different communications channel. In some instances, the user device may be different than a mobile device at which a digital version of a credit card associated with a new credit account will be stored in a mobile wallet. As such, the credit application can be received from any suitable computer or device.

At 410, the financial institution can perform a credit adjudication process based on the received credit application. The credit adjudication process can be any suitable process, and may include obtaining additional information from the customer, an existing customer account, one or more credit bureaus, or one or more other information sources. Based on the information from the completed application, the credit adjudication process for the user can be performed, and, in response to approval of the application for credit by the credit adjudication process, a new credit account can be created at the financial institution for the customer at 415. The new credit account can be associated with a unique credit account identifier, which may be a personal account number for an associated payment card or any suitable identifier. Additionally, a set of customer credentials can be generated for future logins and accessing of the new credit account information. The set of customer credentials may be a login identifier and password, or a unique character string used to confirm and validate the particular customer in at least one initial interaction with a secure financial application prior to provisioning a digital version of a credit card associated with the new account.

At 420, the financial institution can generate and transmit a second signal including an indication of the approved credit application and the set of customer credentials associated with the account. The second signal can be transmitted to the customer associated with the new credit account. In some instances, the second signal can be sent through the same communication channel through which the credit application was received. For example, if the credit application was received through a mobile application of the user, the notification can be transmitted back to the same mobile application. Alternatively, the second signal can be transmitted in a different communication channel than the credit application was received.

At 425, the financial institution can generate and transmit a third signal that includes an instruction for the customer or user to open the secure financial application at the client device associated with the customer. The instruction can include an instruction to download and/or install the secure financial application if it is not available at the user device. In some instances, the instruction can include a link or interactive element that can be selected, at the client device, and cause the secure financial application to be launched, or can take the customer to an app store link corresponding to the secure financial application. In some instances, the third signal may be included in or a part of the second signal and sent in the same transmission. In other instances, the third signal may be sent separately, and may be sent through a different communication channel than which the second signal is transmitted.

At 430, a fourth signal can be received from the secure financial application executing on the mobile device, the fourth signal including a login request associated with and/or including the set of customer credentials associated with a particular credit account. The secure financial application can establish a secure connection to the financial institution, such that transmissions sent to and received from the secure financial application are protected from interception of sensitive financial data. At 435, the received set of customer credentials are validated for the customer and the new credit account.

In response to successfully validating the set of customer credentials, the financial institution can provide an authorization or instruction to initiate onboarding procedures for the new credit account and its associated credit card via the secure financial application. In some instances, a fifth signal may be transmitted to the secure financial application indicating the successful validation and allowing the start of the onboarding procedure.

At 445, at the secure financial application, a three-party handshake between the secure financial application, a mobile wallet provider and/or mobile wallet application executing at the client device, and a payment network token service can be performed. In response to a successful handshake and the confirmation of the operations to be performed, the mobile wallet of the client device can receive digital issuance of a digital version of the credit card of the new credit account (e.g., a payment token) from the payment network token service at 450. At 455, the digital version of the credit card can be stored, or provisioned, to the mobile wallet. Once provisioned to the mobile wallet, the customer can immediately perform financial transactions with one or more merchants or providers using the digital version of the card in the mobile wallet.

The preceding figures and accompanying description illustrate example processes and computer-implementable techniques. However, system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system comprising:
a communications module;
at least one memory storing instructions and a repository storing a set of credit accounts, each credit account associated with a user and a user-specific set of credentials;
at least one hardware processor interoperably coupled with the at least one memory and the communications module, wherein the instructions instruct the at least one hardware processor to:
receive, via the communications module, a first signal including data associated with an application for a credit account for a first user;
perform a credit adjudication process based on the received data associated with the application for the credit account for the first user;
in response to an approval during the credit adjudication process, create a new credit account associated with the first user, the new credit account associated with a set of first user-specific credentials;
transmit, via the communications module and through a first communication channel, a second signal including an indication of the approval of the credit application and the set of first user-specific credentials;
transmit, via the communications module and through a second communication channel, a third signal including an instruction request opening of a secure financial application at a mobile device associated with the first user;
receive, via the communications module and from the secure financial application executing on the mobile device associated with the first user, a fourth signal including a login request associated with the set of first user-specific credentials; and
in response to validating the received set of first user-specific credentials as associated with the first user and the new credit account, transmit, via the communications module and to the secure financial application, a fifth signal including an indication to allow initiation of onboarding procedures for a digital version of a payment card associated with the new credit account at the mobile device, wherein, in response to fifth signal, the secure financial application initiates interaction between the secure financial application, a mobile wallet application associated with a mobile wallet of the mobile device, and a payment network token service, wherein, in response to the initiated interaction, the payment network token service transmits, via a sixth signal to the mobile wallet executing on the mobile device, a generated digital version of the payment card associated with the new credit account, and wherein the mobile wallet stores the digital version of the payment card for use in future transactions.

2. The system of claim 1, wherein the first signal including data associated with the application for the credit account for the first user is received from a first device different than the mobile device.

3. The system of claim 1, wherein the first signal including data associated with the application for the credit account for the first user is received from a client application executing at the mobile device.

4. The system of claim 1, wherein the secure financial application comprises a mobile banking application provided by a financial institution, and wherein the secure financial application is configured to create a secure communications channel to the financial institution.

5. The system of claim 1, wherein the interaction between the secure financial application, the mobile wallet application, and the payment network token service comprises a three-way handshake between the secure financial application, the mobile wallet application, and the payment network token service.

6. The system of claim 1, wherein storing the digital version of the payment card for use in future transactions is performed before a physical version of the payment card is generated.

7. The system of claim 1, wherein no physical version of the payment card is generated for the new credit account.

8. The system of claim 1, wherein the second signal and the third signal are sent in a single signal via a common communications channel.

9. The system of claim 1, wherein the first communication channel is different than the second communication channel.

10. The system of claim 1, wherein the instruction requesting opening of the secure financial application at the mobile device associated with the first user includes an instruction to download the secure financial application from an app store corresponding to an operating system of the mobile device if the secure financial application is not installed on the mobile device.

11. The system of claim 1, wherein the digital version of the payment card associated with the new credit account comprises a payment token generated by the payment network token service, wherein the payment token is used in lieu of a personal account number (PAN) to complete transactions using the new credit account.

12. A non-transitory, computer-readable medium storing computer-readable instructions executable by a computer and configured to:
receive a first signal including data associated with an application for a credit account for a first user, wherein the credit account for the first user is stored in a repository of credit accounts, wherein each credit account is associated with a particular user and a user-specific set of credentials;
perform a credit adjudication process based on the received data associated with the application for the credit account for the first user;
in response to an approval during the credit adjudication process, create a new credit account associated with the first user, the new credit account associated with a set of first user-specific credentials;
transmit, through a first communication channel, a second signal including an indication of the approval of the credit application and the set of first user-specific credentials;
transmit, through a second communication channel, a third signal including an instruction request opening of a secure financial application at a mobile device associated with the first user;
receive, from the secure financial application executing on the mobile device associated with the first user, a fourth signal including a login request associated with the set of first user-specific credentials; and
in response to validating the received set of first user-specific credentials as associated with the first user and the new credit account, transmit, to the secure financial application, a fifth signal including an indication to allow initiation of onboarding procedures for a digital version of a payment card associated with the new credit account at the mobile device, wherein, in response to fifth signal, the secure financial application initiates interaction between the secure financial application, a mobile wallet application associated with a mobile wallet of the mobile device, and a payment network token service, wherein, in response to the initiated interaction, the payment network token service transmits, via a sixth signal to the mobile wallet executing on the mobile device, a generated digital version of the payment card associated with the new credit account, and wherein the mobile wallet stores the digital version of the payment card for use in future transactions.

13. The computer-readable medium of claim 12, wherein the first signal including data associated with the application for the credit account for the first user is received from a first device different than the mobile device.

14. The computer-readable medium of claim 12, wherein the first signal including data associated with the application for the credit account for the first user is received from a client application executing at the mobile device.

15. The computer-readable medium of claim 12, wherein the secure financial application comprises a mobile banking application provided by a financial institution, and wherein the secure financial application is configured to create a secure communications channel to the financial institution.

16. The computer-readable medium of claim 12, wherein the interaction between the secure financial application, the mobile wallet application, and the payment network token service comprises a three-way handshake between the secure financial application, the mobile wallet application, and the payment network token service.

17. The computer-readable medium of claim 12, wherein storing the digital version of the payment card for use in future transactions is performed before a physical version of the payment card is generated.

18. The computer-readable medium of claim 12, wherein no physical version of the payment card is generated for the new credit account.

19. The computer-readable medium of claim 12, wherein the digital version of the payment card associated with the new credit account comprises a payment token generated by the payment network token service, wherein the payment token is used in lieu of a personal account number (PAN) to complete transactions using the new credit account.

20. A computerized method performed by one or more processors, the method comprising:
receiving a first signal including data associated with an application for a credit account for a first user, wherein the credit account for the first user is stored in a repository of credit accounts, wherein each credit account is associated with a particular user and a user-specific set of credentials;
performing a credit adjudication process based on the received data associated with the application for the credit account for the first user;
in response to an approval during the credit adjudication process, creating a new credit account associated with the first user, the new credit account associated with a set of first user-specific credentials;
transmitting, through a first communication channel, a second signal including an indication of the approval of the credit application and the set of first user-specific credentials;
transmitting, through a second communication channel, a third signal including an instruction request opening of a secure financial application at a mobile device associated with the first user;
receiving, from the secure financial application executing on the mobile device associated with the first user, a fourth signal including a login request associated with the set of first user-specific credentials; and
in response to validating the received set of first user-specific credentials as associated with the first user and the new credit account, transmitting, to the secure financial application, a fifth signal including an indication to allow initiation of onboarding procedures for a digital version of a payment card associated with the new credit account at the mobile device, wherein, in response to fifth signal, the secure financial application initiates interaction between the secure financial application, a mobile wallet application associated with a mobile wallet of the mobile device, and a payment network token service, wherein, in response to the initiated interaction, the payment network token service transmits, via a sixth signal to the mobile wallet executing on the mobile device, a generated digital version of the payment card associated with the new credit account, and wherein the mobile wallet stores the digital version of the payment card for use in future transactions.
